(19) United States
(12) Patent Application Publication
(10) Pub. No.: US 2013/0097058 A1
(43) Pub. Date: Apr. 18, 2013

(54) BACK DROP SYSTEM AND METHOD

(71) Applicant: Floyd BAKER, Maple Lake, MN (US)

(72) Inventor: Floyd BAKER, Maple Lake, MN (US)

(21) Appl. No.: 13/649,796

(22) Filed: Oct. 11, 2012

Related U.S. Application Data
(60) Provisional application No. 61/546,843, filed on Oct. 13, 2011.

(51) Int. Cl. G03B 15/00; F16B 2/20

(52) U.S. Cl. CPC G03B 15/00; F16B 2/20; G06Q 30/0641
USPC 705/27.1; 396/3; 24/455

(57) ABSTRACT

A backdrop system includes a backdrop, a frame and a backdrop clip for holding the backdrop. The backdrop system also includes a storage system and a system for fulfilling orders.

### RELATED APPLICATIONS

This application claims the benefit under 35 U.S.C. §119(e) of prior U.S. Provisional Patent Application No. 61/546,843, filed Oct. 13, 2011, which is incorporated herein by reference.

### TECHNICAL FIELD

Various embodiments described herein relate to a back drop system and a method for using the same.

### BACKGROUND

Recently, there has been an increase in the quality of cameras. Currently, the cost of a high quality digital camera, although not cheap, is low enough so that the barrier to entry for photographers wanting to open a photography studio is low. As a result, there are many entrepreneurs entering the photography studio business. Of course, putting together a photography studio requires more than just a camera. In addition to having a space, and an assortment of lights, the photographer typically needs a backdrop system so that various backdrops can be used to bring out the best in the subjects. In addition, backdrops can be used to replicate outdoor scenes indoors, provide textures or create whimsical/cartoon like backgrounds behind subjects.

In the past, backdrops have been formed on sheets of linen material. In one system, several sets of backdrops are rolled up on a single roll. The roll can be mounted on a wall at the back of the space. The desired backdrop can be selected and placed behind the subject. The rolls typically wear on the edges of the backdrop. In addition, the linen sheets are heavy. If the sheets need changing, serious muscle is needed to handle the roll that includes a number of linen sheets. This is problematic when you consider that the demographics of the fastest growing group of photographers opening studios are females between the ages of 25-35. Photographers in this age group may not necessarily have the strength and ability to easily rearrange these backdrops during the course of a photo-shoot.

In another system, a frame is provided and a backdrop is draped over the frame and held in place with very large clips. The large clips must be opened so that they fit around the frame members. The clips include return springs. The clips require some strength to open so that it can be snapped around the frame member. All this has to be done while a heavy linen cloth is held in place. Again, this may not be the easiest task for a person getting started as a studio photographer.

Still another problem can be storage of these various backdrops. Typically, the backdrops are rolled onto cardboard or other tubes and propped up in a corner of the studio. In that same vein, some storage units sit on the floor and take up valuable real estate. One storage unit includes a grid having individual openings therein. A rolled up backdrop must be lifted off the floor to a height over the top level of the bin. The rolled up backdrop must then be guided toward an empty opening and dropped into the appropriate slot. Again, this may not be the easiest maneuver for a photographer to accomplish. Regardless, this solution takes up valuable floor space and has a larger footprint than necessary.

### BRIEF DESCRIPTION OF THE DRAWINGS

FIG. 1 is a perspective view of a backdrop system, according to an example embodiment.

FIG. 2 is a view showing the large clips, used in prior art systems, for hanging a backdrop.

FIG. 3 is a top view of a backdrop clip, according to an example embodiment.

FIG. 4 is an exploded view of the clip mechanism associated with the backdrop clip, according to an example embodiment.

FIG. 5 is a view of the clip mechanism opened and showing the enhanced edges on the clamping end, according to an example embodiment.

FIG. 6 is a view of the backdrop clip holding a backdrop on a frame, according to an example embodiment.

FIG. 7 is a view of another embodiment of the backdrop clip which is tailored to holding a backdrop with grommets, according to an example embodiment.

FIG. 8 is a view showing the large clips, used in prior art systems, for hanging a backdrop.

FIG. 9 is a view of modular portion of a storage system, according to an example embodiment.

FIG. 10 is a view of a storage system, according to an example embodiment.

FIG. 11 is a flow diagram associated with a computerized method, according to an example embodiment.

FIG. 12 shows a schematic diagram of a computer system used in the system for driving business, according to an example embodiment.

### DETAILED DESCRIPTION

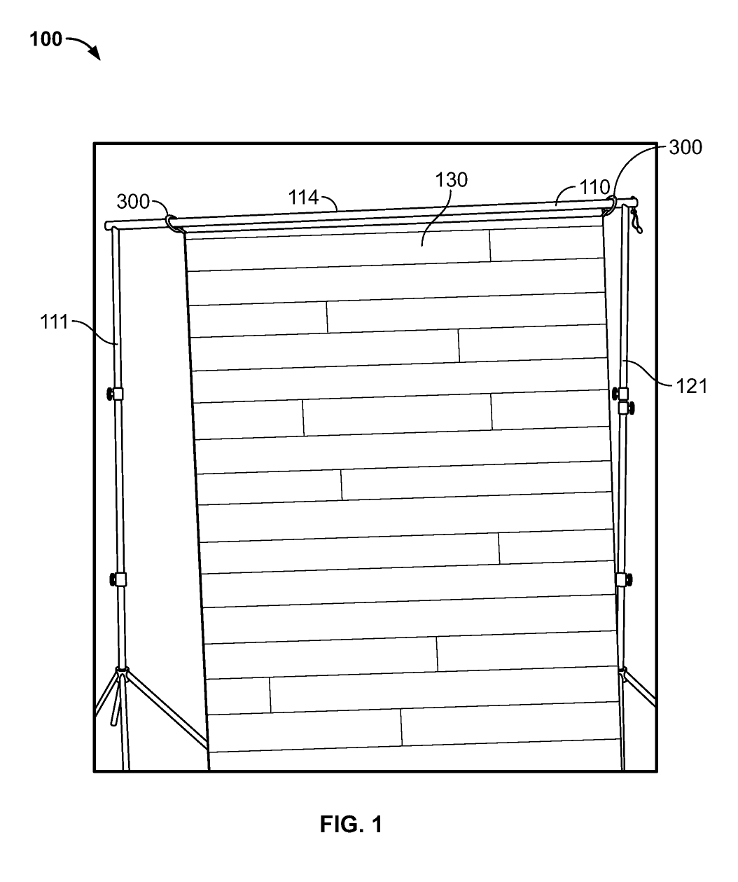

FIG. 1 is a perspective view of a backdrop system 100, according to an example embodiment. The backdrop system 100 includes a frame system 110 that includes a first upright 111 and a second upright 121. The first upright includes a set of legs 112. As shown, there are three legs that allow the first upright 111 to stand or remain in a substantially vertical orientation. The second upright 121 also includes a set of legs 122. As shown, there are three legs that allow the second upright 121 to stand or remain in a substantially vertical orientation. The frame 110 also includes a cross member 114 that is attached to the first upright 111 and the second upright 121. The frame system 110 is adjustable. In addition, in some embodiments, the frame system 110 is highly portable. The support legs of the first upright 111 and the second upright 121 can be moved to a position where the legs are near their respective upright and substantially parallel to the upright 111, 121. The cross member 114 can also be broken down. The result is that there are about three pieces that can be attached to one another or which can be placed into a carrying case for easy transport.

The backdrop system 100 includes a lightweight backdrop 130. The lightweight backdrop 130 is formed on a lightweight, durable substrate using an Industrial Digital Printer, such as an HP Designjet T1200 HD Multifunction Printer. Digital Printers produce an image on a substrate using a non-impact printing process where a set of devices “fires” drops of ink from the print heads onto the substrate. Digital Printers have print heads that use PZT crystals as micro-pumps to eject the droplets of ink from a nozzle. The crystals deform to generate a “shock wave” in the fluid inks which in turn ejects a drop from the nozzle. A combination of surface tension, capillary pressure and other complex fluid dynamics ensures that the fluid is refilled ready for the next fire cycle. The Digital Printers are capable of printing to a variety of substrates and are generally characterized by the formats which can be produced.

Wide format printers are generally capable of printing from 10 to 60 square metres per hour. These Digital Printers are capable machines are now available from 0.9 metres to 3 metres wide. Generally a roll of substrate is placed in the machine and images are printed continuously on the roll. These machines cut the roll upon completion of a particular print job. Wide format printers are available from many manufacturers. For example, one wide format printer is an HP Designjet L25500 60″ Printer which is available from Hewlett Packard of Palo Alto, Calif., USA. Hewlett Packard offers other printers capable of printing to media which are wider and narrower.

Super wide printer format are also roll-to-roll and have a print bed that is 2 m to 5 m wide. Super wide printer format Digital Printers are mostly used for printing billboards and generally have the capability of printing between 60 to 160 square metres per hour.

The backdrops are produced on lightweight, durable substrates or print media, such as an 8 mil HP Everyday Matte Polypropylene CH027A, a 13.4 mil HP Opaque Scrim Vinyl Banner Q1902B or a 22 mil HP Professional Matte Canvas HEWQ8672A. These materials are readily available from Hewlett Packard or one of their many resellers.

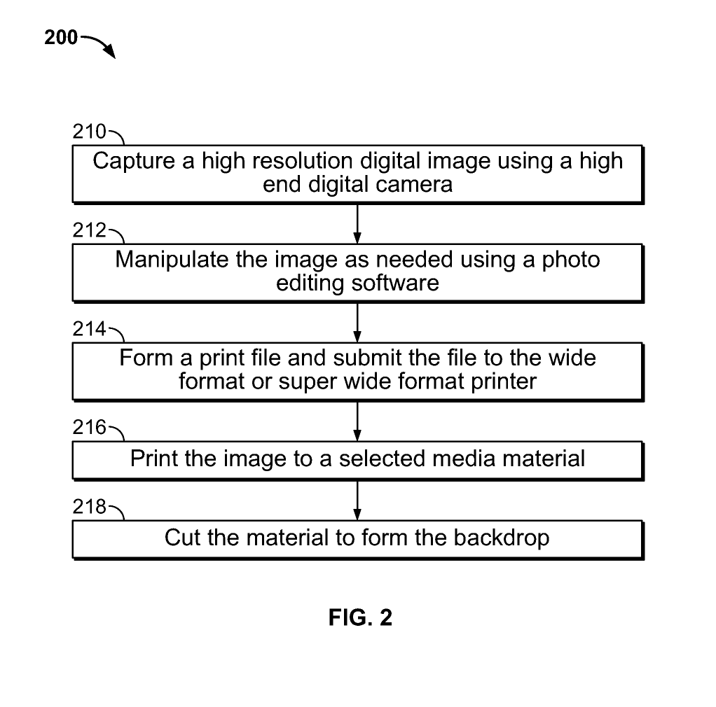

FIG. 2 is a flow diagram 200 of a method for making the backdrops. The backdrops 130 can be formed in any number of ways. In one example embodiment, a high resolution digital image is captured using a high end digital camera 210, such as a Hasselblad H4D-60. The backdrop 130 (shown in FIG. 1) includes an image of a floor, for example. Once the image is captured, it can be manipulated using a photo editing software 212, such as Photo Shop. The backdrop maker can enhance the image or manipulate it in various ways to produce the image desired for the backdrop. In another example embodiment, the files can be painted and scanned, or digitally created entirely within PhotoShop by an artist. The print file is formed and submitted to the wide format or super wide format printer 214. Generally, the printer is capable of handling different types of media such as the poly, vinyl or 100% canvas materials discussed above. Other types of media can also be handled including various fabrics. The poly, vinyl or canvas discussed above have the advantage of being lightweight, durable, and easy to store. A wide format or super wide format printer prints the image to the selected media material 216. Once printed, the material is cut 218 thereby forming the backdrop 130. The above media material is available in rolls which are as wide as the wide format printer.

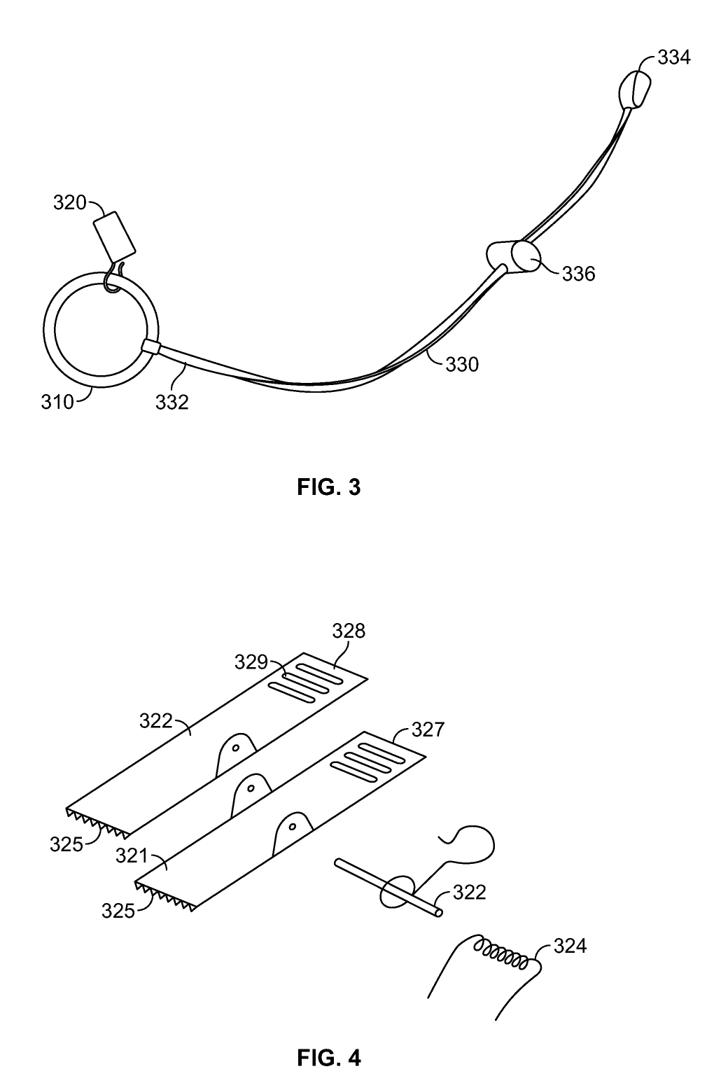

FIG. 3 is a top view of a backdrop clip 300 which is used to clip or hold a backdrop 130 to the frame system 110 (shown in FIG. 1), according to an example embodiment. The backdrop clip 300 includes a main body 310, a clip mechanism 320, and an adjustable portion 330 for adjusting the amount of tension to place on the main body 310 and the clip mechanism 320. As shown, the clip mechanism 320 is attached to the main body 310 and the adjustable portion 330 is also attached to the main body 310. The main body 310, as shown, is a ring.

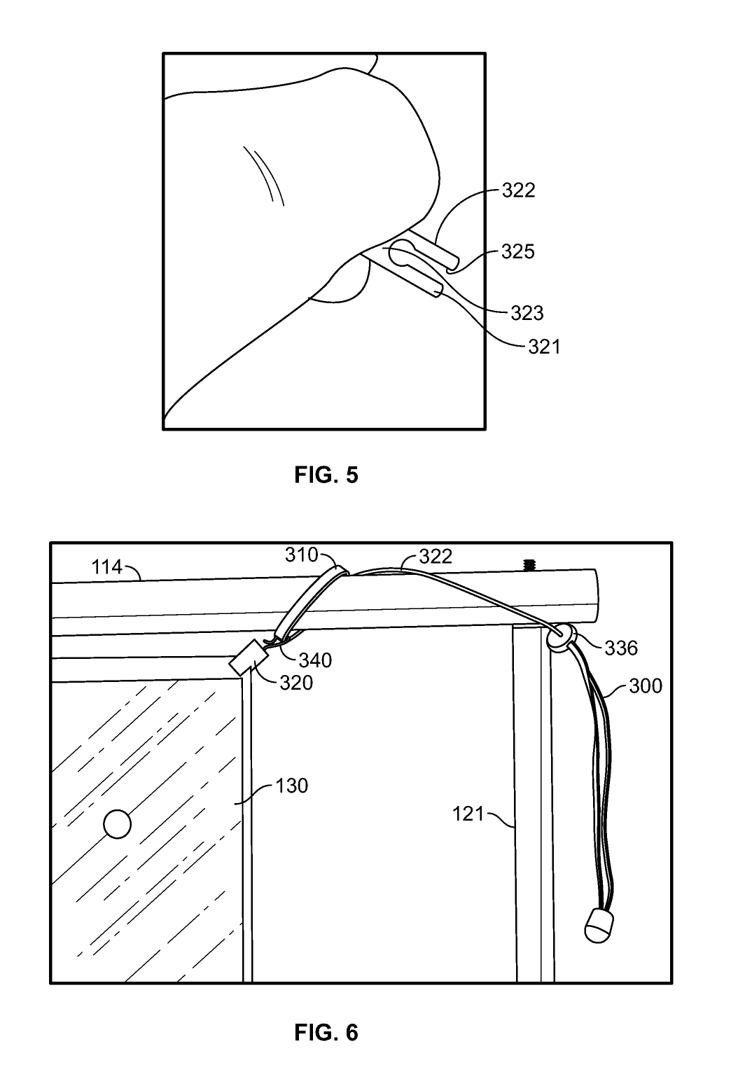

FIG. 4 is an exploded view of the clip mechanism associated with the backdrop clip, according to an example embodiment. FIG. 5 is a view of the clip mechanism opened and showing the enhanced edges on the clamping end, according to an example embodiment. Now referring to FIGS. 3-5, the clip mechanism 320 will be further detailed. Some would describe the clip mechanism 320 shown as a version of an alligator clip. The clip mechanism 320 includes a first half 321 and a second half 322 which are pivotally attached to one another with a pin or shaft 323. A coil spring 324 is position around the pin or shaft 323 such that the coil spring forces the first half 321 and the second half 322 toward one another at a clamping end 325 of the clip mechanism. The coil spring 324 is selected so that it produces a clamping force at the clamping end 325 of the clip mechanism 320 sufficient to hold the backdrop 130 in a stretched or taut position with respect to the frame. At the clamping end 325 of the clip mechanism 320, the first half 321 and the second half 322 of the clipping mechanism may have a surface which aids in holding an item, such as a backdrop 130. The surface may include a rubberized or elastomeric surface. In the embodiment shown, the first half 321 and the second half 322 are provided with teeth at the clamping end 325 to focus the clamping force and produce points of high pressure that help with holding an object (shown best in FIG. 5). The free end 327 of the first half 321 and the free end 328 of the second half 322 include features which aid a user in placing a force onto the free ends 327, 328. As shown, the free end 327 and the free end 328 both have ribs 329 which provide a bit more friction for gripping the free ends 327, 328 to apply a force to the free ends 327, 328 and open the clamping end 325 of the clip mechanism 320.

The clip mechanism 320 also includes a connector 340 for connecting the clip mechanism 320 to the main body 310. The connector 340 includes a substantially closed end 342 which wraps around the shaft 322 and the coil spring 324 so as to stay substantially permanently attached to the clip mechanism 320. The connector 340 also has an open end 344 which is C-shaped and has indentations to allow another main body to be attached to clip mechanism 320. As shown, the main body 310 is a ring. It should be noted that the main body 310 can have any shape such as a square or rectangular “ring”. The main body 310, as shown, has an opening therein that can fit around the frame members.

Now turning back mainly to FIG. 3, the backdrop clip 300 also includes an adjustment mechanism 330. The adjustment mechanism 330 includes a cord 332 and a stopper 334. In the embodiment shown, the cord 332 is an elastomeric cord which can be stretched to apply additional tension. The elastomeric cord 332 includes the stop 334 which connects the ends of the elastomeric cord. As shown, the stop 334 is a plastic member. It should be noted that a knot could be used as a stop. The ends of the elastomeric cord 332 could be knotted together using a common overhand knot to form a stop 334. A cord lock 336 or spring loaded adjustable stop is also provided on the cord 332 intermediate the stop 334 and the main body 310 of the backdrop clip 300. The cord lock 336 allows for easy adjustment of the cord length. When the cord is elastomeric, the cord lock 336 can be used to fine tune the amount of tension to place on the clip mechanism 320 of the backdrop clip 300. The elastomeric cord 332 is connected to the main body 310.

FIG. 6 is a close up view of the backdrop clip 320 holding a backdrop 130 on a frame 110, according to an example embodiment. The portion of the frame 110 shown includes the upright 121 and the cross member 114. The main body 310 of the adjustable portion 330 fits over the cross member 114 of the frame system 110. The clip mechanism 320 and specifically the clamping end 325 is clamped to the corner of the backdrop 130. The elastomeric cord 332 is stretched over the corner of the upright 121 and the cross member 114 of the frame 110. The cord stop 336 is used to hold the cord 332 in a stretched position. The cord stop 336 can be loosened to place less tension on the backdrop 130 or can be further tightened to place more tension on the backdrop 130. The cord stop 336 allows the user to keep the length of the cord 332 very close to the desired length. If a cord stop 336 is not used, the cord must be tied off and tried again. The cord stop 336 makes the retries quick and easy to make so that a final adjustment at a desired tension can be more quickly arrived at. This shows only one connection point. Several other backdrop clips 300 can be used at the corners and along the sides of the backdrop 130 to hang it with a desired amount of tension.

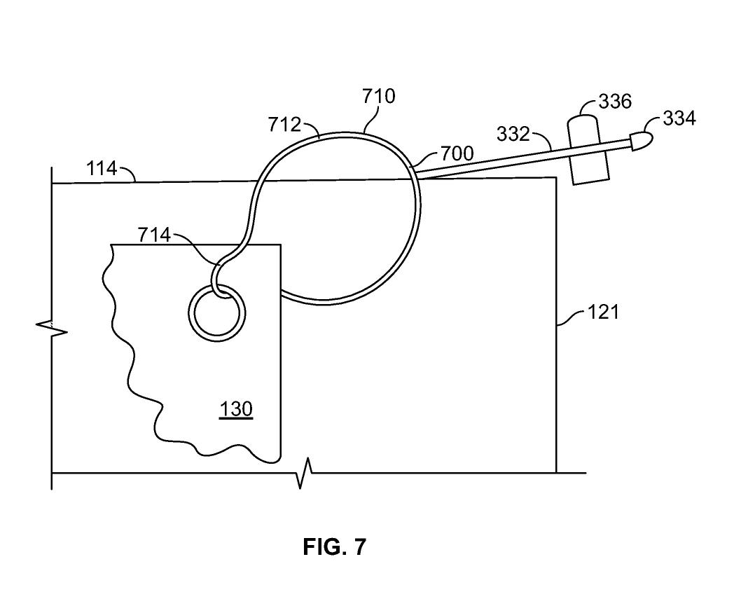

FIG. 7 shows another embodiment of the backdrop clip 700. The backdrop clip 700 is used for tensioning and hanging a backdrop having grommets along the edges. The backdrop clip 700 includes a main body 710 which is a grommet ring. The grommet ring 710 includes a first ring portion 712 sized to fit around the frame 110 and a second ring portion 714 which fits within a grommet of a backdrop. The backdrop clip 700 also includes an adjustment mechanism 330 which is substantially identical to the one described above for backdrop clip 300. The adjustment mechanism 330 includes a cord 332 and a stopper 334. The cord 332 is an elastomeric cord which can be stretched to apply varying amounts of tension to the grommet of the backdrop. The elastomeric cord 332 includes the stop 334 which connects the ends of the elastomeric cord. As shown, the stop 334 is a plastic member. A cord stop is positioned along the length of the cord and allows for easy adjustment of the tension.

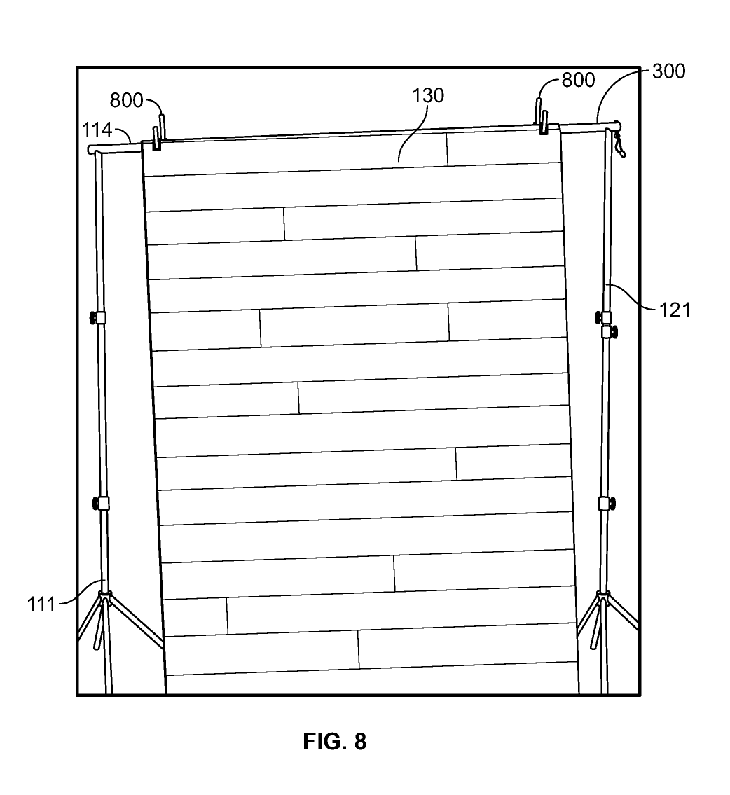

FIG. 8 is a view showing the large clips 800, used in prior art systems, for hanging a backdrop. The large clips 800 require that the user drape at least the top of the backdrop 130 over the cross member 114 of the frame 110. Once draped over the cross member 114, the clamp must be opened and placed over the cross member 114 and the portion of the backdrop 130 draped over the cross member 114. Once one side is done, the other side of the backdrop must be brought into place, a second large clamp must be opened and placed over the backdrop 130. There are many disadvantages to such a system. Among the disadvantages is that the force required to open the large clamp 800 is much larger than the force needed to open the clipping mechanism 320. Furthermore, the backdrop must be tensioned by the user. The clamp 800 merely holds the backdrop 130 in place after the user has stretched the backdrop. There is no easy adjustment of the tensioning force and at least one clamp 800 must be removed to adjust the tension on the backdrop. The clamp 800 is more difficult to use. There is a possibility that the backdrop may become partially undraped between clamping one side of the top of the backdrop and the other side of the backdrop. In some instances this could form a crease in a backdrop or otherwise damage a backdrop.

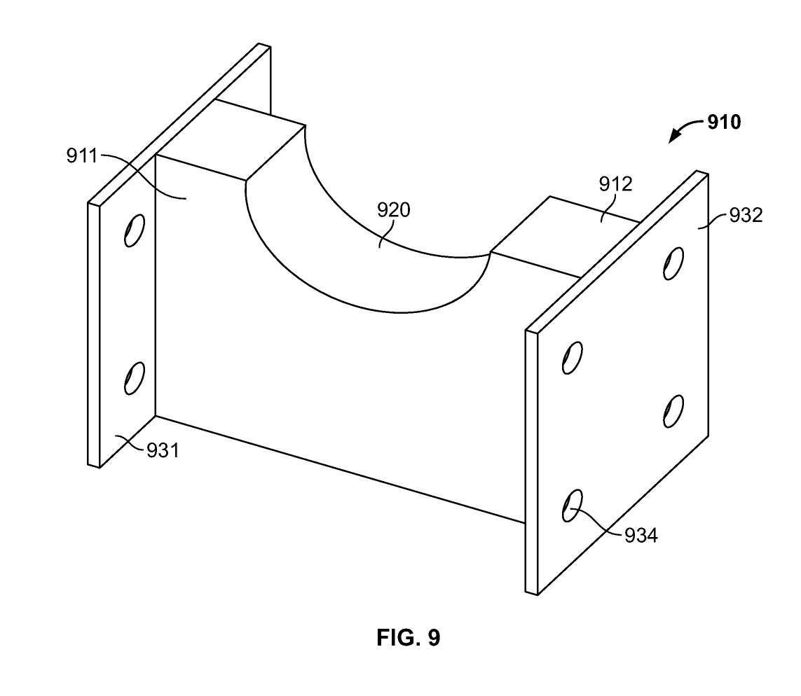

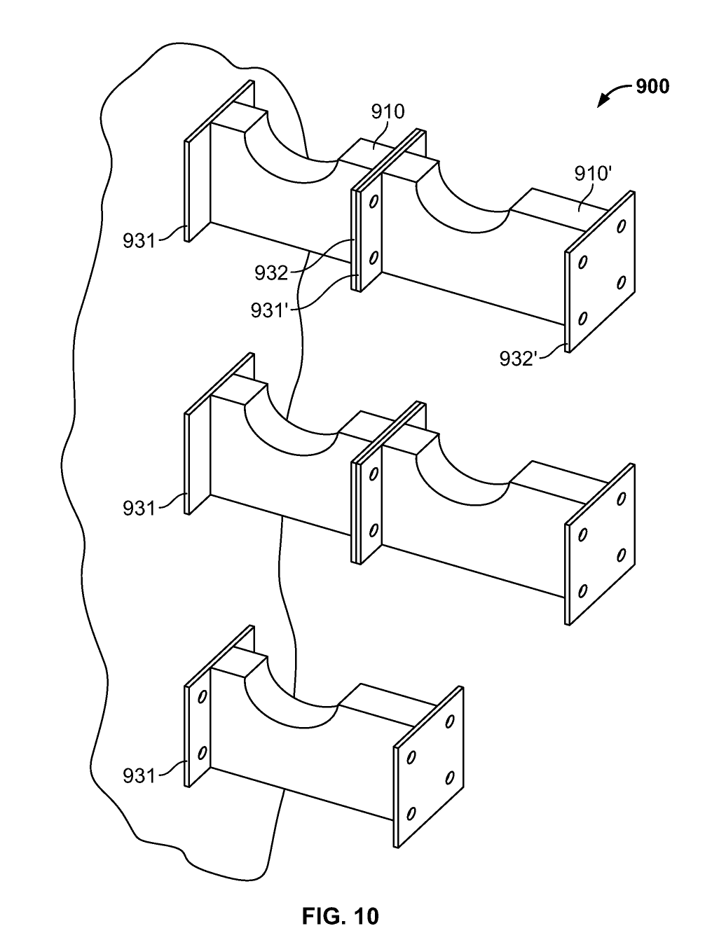

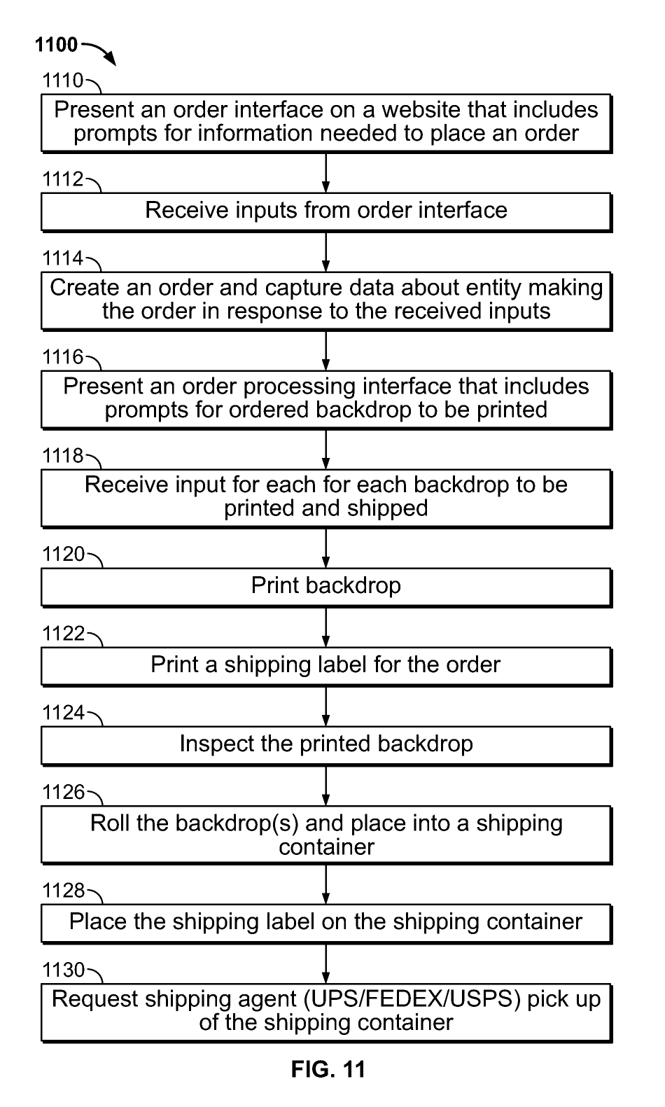

FIG. 9 is a view of a storage system 900, according to an example embodiment. The backdrop system 100 also includes the storage system 900. FIG. 10 is a view of modular portion 910 of a storage system. Now referring to both FIGS. 9 and 10, the storage system will be further detailed. The storage system 900 can be mounted to a vertical surface such as a wall. The storage system 900 is comprised of modules 910. A module 910 includes an arcuate cradle 920 having a radius somewhat bigger than the radius of a rolled up backdrop 130. The backdrops 130 are generally rolled up for storage as this results in less damage to the backdrop 130. The module 910 also includes a first end 911 and a second end 912. One of both of the ends 911, 912 are provided with connectors 931 and 932, respectively. The connectors 931, 932 shown in FIGS. 9 and 10 include flanges which are attached to the ends 911, 912. In one embodiment, the flanges include fastener openings, such as 934. Fasteners can then be used to attach a flange connector 931 to a wall or other vertical surface. For example, screws can be used on second end 912 to attach the connector 932 to the wall. Fasteners can also be used to connect the first end 931 to the flange connector, such as connector 932′ of another module 910′. A number of modules can be connected together to produce an extended shelf comprised of multiple modules. FIG. 10 shows one column of modules formed on a wall. It should be understood that another similar column would be placed a distance away from the column shown to complete the shelf arrangement of the storage system.

In another embodiment, the connectors at the ends are interlocking mechanisms that attach to the end of the modules. The connectors can then be snapped into place or slid into place to hold with respect to one another. In this embodiment, separate fasteners would not be needed to attach the various modules to one another but would be needed to attach an “end” to the wall.

Several rows of the modules 910 can be formed on a wall. This allows for flexibility in designing a storage system. It also allows for completely customized result that keeps the floor clear of storage bins and the like. The system can be customized to a users height. For example, if a shorter woman is the main person using the storage system, the “shelves” can be lowered to a position which she likes. The modules, in one embodiment, are even provided with label holders so the person can label the position on the storage unit for a particular backdrop 130 and know exactly what is in the arcuate slots for the rolls. It should be noted that many times the rolls are rolled with the blank side facing out so as to protect the image on the backdrop. This saves time in that the user does not have to unroll several backdrop rolls to find a desired backdrop needed for a set of pictures.

In some embodiments, the backdrop system includes a sales and fulfillment component and includes a computerized method 1100 for fulfillment or orders, according to an example embodiment. The computerized method 1100 for fulfillment of orders described in the example is for fulfilling orders for backdrops. It should be noted that orders may be fulfilled for any type of item. The computerized method 1100 includes presenting an order interface on a website that includes prompts for information needed to place an order 1110, and receiving inputs from order interface 1112. In response to these inputs, the computerized method includes creating an order and capturing data about entity making the order 1114. An order processing interface is presented that includes prompts for ordered backdrop to be printed 1116. An input for each backdrop to be printed and shipped is received 1118. The backdrop is printed 1120. In one example embodiment, the print job is automatically sent to a wide format or super wide format printer to print the backdrop. A shipping label is also printed for the order 1122. In one example embodiment, the shipping label is automatically created. The printed backdrop is inspected 1124. The backdrops needed to fulfill the order are placed into a shipping container 1126. A shipping label is placed onto the shipping container 1128. The computerized method 1100 also requests the shipping agent (such as UPS/FedEx/USPS) to pick up of the shipping container 1130.

In other words, a set of software instructions are used to prompt users to make an Order typically via a website, and prompt the order to be fulfilled. In response to inputs received at an order page or an order interface, the website ordering system adds the customer and order information to a processing workflow area, such as to a database table in the memory of a computer system. The software allows an order fulfillment user to edit the users information (address, phone, email etc.) as well as the order information. For example, the modifications can be used to note which backdrops or other items were purchased as well as record notes about the order or transaction. The fulfillment system executes an instruction set to print the backdrops, and to print a shipping label from a shipping partner, such as UPS, FedEx, or USPS. The fulfillment system also records the tracking number for later lookup as necessary. The backdrops are inspected, rolled and packed into shipping tubes. The instruction set also adds the order information to an accounting program, such as Quickbooks for accounting and tax purposes. For each order the fulfillment system awards “loyalty points” automatically based on the amount of the order. Checking a checkbox next to the name of a backdrop sends the backdrop design ordered by the customer to one of the printers automatically. Once all backdrops for an order are sent to the printer the fulfillment system executes instructions to move the entire order from the order processing screen to a shipping screen. For each order on the shipping screen, clicking the “ship” link interfaces with United Parcel Service's (UPS's) API to produce and automatically print a shipping label with the appropriate customer address, weight and size dimensions. The tracking number is automatically recorded and a note is automatically left stating the fee charged by UPS/FedEx/United States Postal Service for the shipment.

Once the label is done, the order moves to the Tracking tab. The processing software users only needed action is to click the “ship” link. The tracking tab displays the order information for all packages that are in transit with a link directly to the tracking information on UPS website. UPS sends an email when they confirm delivery of the package. When the delivery email is received from UPS by the order fulfillment system, the order is automatically moved from the tracking tab to the history tab. No action is required by the software user, but if the software user needs to check the status of an order in transit, they simply click the history tab link and are taken directly to the tracking information). The history tab displays a historical record of the orders that have been received as well as a search box to lookup orders. Nightly a batch process takes the customer and order information from orders that have been received and adds it to Quickbooks automatically.

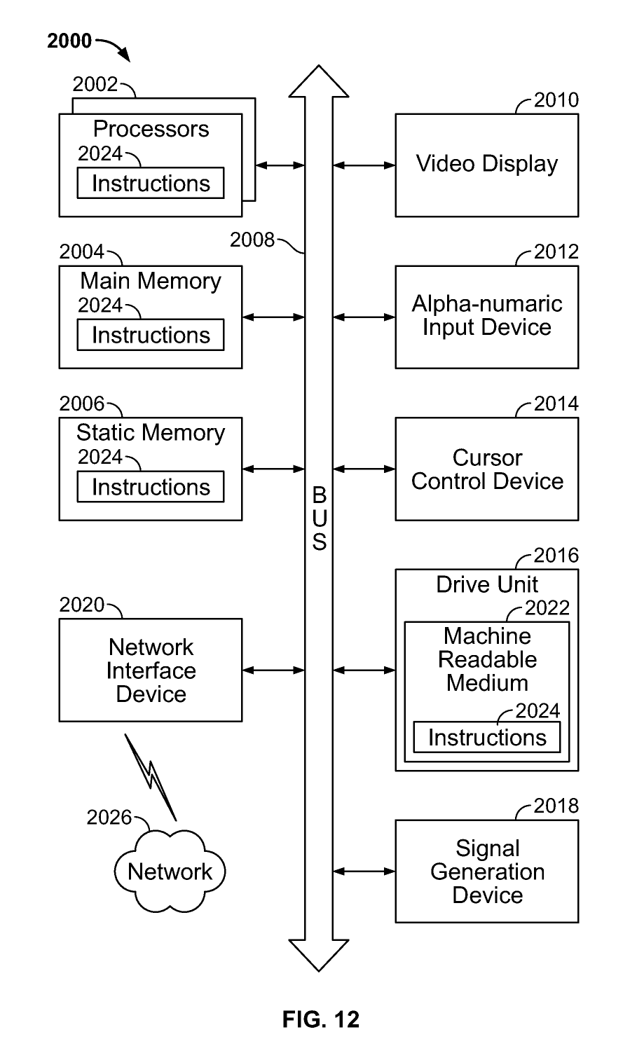

FIG. 12 shows a diagrammatic representation of a computing device for a machine in the example electronic form of a computer system 2000, within which a set of instructions for causing the machine to perform any one or more of the fulfillment methodologies discussed herein can be executed or is adapted to include the apparatus for fulfilling orders as described herein. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player, a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor or multiple processors 2002 (e.g., a central processing unit (CPU), a graphics processing unit (GPU), arithmetic logic unit or all), and a main memory 2004 and a static memory 2006, which communicate with each other via a bus 2008. The computer system 2000 can further include a video display unit 2010 (e.g., a liquid crystal displays (LCD) or a cathode ray tube (CRT)). The computer system 2000 also includes an alphanumeric input device 2012 (e.g., a keyboard), a cursor control device 2014 (e.g., a mouse), a disk drive unit 2016, a signal generation device 2018 (e.g., a speaker) and a network interface device 2020.

The disk drive unit 2016 includes a computer-readable medium 2022 on which is stored one or more sets of instructions and data structures (e.g., instructions 2024) embodying or utilized by any one or more of the methodologies or functions described herein. The instructions 2024 can also reside, completely or at least partially, within the main memory 2004 and/or within the processors 2002 during execution thereof by the computer system 2000. The main memory 2004 and the processors 2002 also constitute machine-readable media.

The instructions 2024 can further be transmitted or received over a network 2026 via the network interface device 2020 utilizing any one of a number of well-known transfer protocols (e.g., Hyper Text Transfer Protocol (HTTP), CAN, Serial, or Modbus).

While the computer-readable medium 2022 is shown in an example embodiment to be a single medium, the term “computer-readable medium” should be taken to include a single medium or multiple media (e.g., a centralized or distributed database, and/or associated caches and servers) that store the one or more sets of instructions and provide the instructions in a computer readable form. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, tangible forms and signals that can be read or sensed by a computer. Such media can also include, without limitation, hard disks, floppy disks, flash memory cards, digital video disks, random access memory (RAMs), read only memory (ROMs), and the like.

When the computerized method 1100, discussed above, is programmed into a memory of a general purpose computer described in FIG. 12, the computer and instructions form a special purpose machine. The instructions, when programmed into a memory of a general purpose computer, are in the form of a non transitory set of instructions. The example embodiments described herein can be implemented in an operating environment comprising computer-executable instructions (e.g., software) installed on a computer, in hardware, or in a combination of software and hardware. Modules as used herein can be hardware or hardware including circuitry to execute instructions. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method(s) can be written in any number of suitable programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

The present disclosure refers to instructions that are received at a memory system. Instructions can include an operational command, e.g., read, write, erase, refresh, etc., an address at which an operational command should be performed, and the data, if any, associated with a command. The instructions can also include error correction data.

A backdrop system includes a frame, and a pattern printed on a lightweight material. The backdrop system also includes a main body attached to the frame, a clip attached to the lightweight material and to the main body, and an adjustable portion attached to the main body for determining the amount of tension to place on the main body and the clip. The lightweight material can be a matte polypropylene material, a vinyl banner material, or the like. The lightweight material can be made having a plurality of thicknesses. The lightweight material has a width in a range of 0.9 meters to 3 meters. The thickness generally allows one to roll the material for storage and unroll the material for use as a backdrop. In one embodiment, the pattern printed on the lightweight material is a photo image. In another embodiment, the pattern printed on the lightweight material is manipulated using a photo editing software. The adjustable portion includes an elastomeric cord and a cord stop, the cord stop used to vary the length of the elastomeric cord to adjust the amount of tension placed on the main body and the clip attached to the lightweight material. The adjustable portion attaches the lightweight material backdrop to the frame and is used to hold the backdrop material with respect to the frame.

In one embodiment, the backdrop system further includes a plurality of lightweight materials having images for backdrops thereon in which the lightweight materials rolled for storage. The backdrop system further includes a storage system for storing the plurality of rolled lightweight materials. The storage system includes arcuate cradles for storing the plurality of rolled lightweight materials. In some embodiments the arcuate cradles are modular. In other embodiments, the storage system includes: a first modular portion; and a second modular portion.

A connector for holding a backdrop includes a main body, a clip attached to the main body, and an adjustable hanger attached to the main body. In one embodiment, the main body is a ring. The ring can be adapted to fit over a frame portion. The clip of the connector has a first end and a second end. The first end of the clip attached to the ring, and the second end of the clip attached to a lightweight backdrop material.

A system for fulfilling orders includes a display, a processor, and

a non-transitory instruction set for fulfilling the order and for producing a product. The instruction set executable on the processor and causing the system to: present an order interface on a display, receive inputs on the order, present an order processing interface; and receive inputs for printing the backdrop. The order interface elicits information needed to complete an order, and the order processing interface elicits information needed to print a backdrop to fulfill the order. The system for fulfilling orders further includes a wide format printer for printing a backdrop, and a printer for printing a shipping label associated with an order. The system for fulfilling orders wherein the instruction set requests a shipping agent to pick up a completed order.

This has been a detailed description of some exemplary embodiments of the invention(s) contained within the disclosed subject matter. Such invention(s) may be referred to, individually and/or collectively, herein by the term “invention” merely for convenience and without intending to limit the scope of this application to any single invention or inventive concept if more than one is in fact disclosed. The detailed description refers to the accompanying drawings that form a part hereof and which shows by way of illustration, but not of limitation, some specific embodiments of the invention, including a preferred embodiment. These embodiments are described in sufficient detail to enable those of ordinary skill in the art to understand and implement the inventive subject matter. Other embodiments may be utilized and changes may be made without departing from the scope of the inventive subject matter. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed:

1. A backdrop system comprising:
a frame;
a pattern printed on a lightweight material;
a main body attached to the frame;
a clip attached to the lightweight material and to the main body; and
a adjustable portion attached to the main body for determining the amount of tension to place on the main body and the clip.

2. The backdrop system of claim 1 wherein the lightweight material is a matte polypropylene material.

3. The backdrop system of claim 1 wherein the lightweight material is a vinyl banner material.

4. The backdrop system of claim 1 wherein the pattern printed on the lightweight material is a photo image.

5. The backdrop system of claim 1 wherein the pattern printed on the lightweight material is manipulated using a photo editing software.

6. The backdrop system of claim 1 wherein the lightweight material has a width in a range of 0.9 meters to 3 meters.

7. The backdrop system of claim 1 wherein the adjustable portion includes an elastomeric cord and a cord stop, the cord stop used to vary the length of the elastomeric cord to adjust the amount of tension placed on the main body and the clip attached to the lightweight material.

8. The backdrop system of claim 1 wherein the lightweight material is rolled for storage.

9. The backdrop system of claim 1 further comprising:
a plurality of lightweight materials having images for backdrops thereon, the lightweight materials rolled for storage; and
a storage system for storing the plurality of rolled lightweight materials.

10. The backdrop system of claim 9 wherein the storage system includes arcuate cradles for storing the plurality of rolled lightweight materials.

11. The backdrop system of claim 9 wherein the storage system includes:
a first modular portion; and
a second modular portion.

12. The backdrop system of claim 11 wherein at least one of the first modular portion and the second modular portion is a cradle portion.

13. A connector for holding a backdrop comprising:
a main body;
a clip attached to the main body; and
an adjustable hanger attached to the main body.

14. The connector for holding a backdrop of claim 13 wherein the main body is a ring.

15. The connector for holding a backdrop of claim 13 wherein the main body is a ring adapted to fit over a frame portion.

16. The connector for holding a backdrop of claim 14 wherein the clip has a first end and a second end, the first end of the clip attached to the ring, and the second end of the clip attached to a lightweight backdrop material.

17. A system for fulfilling orders comprising:
a display;
a processor; and
a non-transitory instruction set for fulfilling the order and for producing a product, the instruction set executable on the processor and causing the system to:
present an order interface on a display, the order interface eliciting information needed to complete an order;
receive inputs on the order;
present an order processing interface, the order processing interface eliciting information needed to print a backdrop to fulfill the order; and
receive inputs for printing the backdrop.

18. The system for fulfilling orders further comprising a wide format printer for printing a backdrop.

19. The system for fulfilling orders further comprising a printer for printing a shipping label associated with an order.

20. The system for fulfilling orders wherein the instruction set requests a shipping agent to pick up a completed order.
